(19) United States
(12) Patent Application Publication
(10) Pub. No.: US 2026/0193451 A1
(43) Pub. Date: Jul. 9, 2026

(54) RUBBER COMPOSITION FOR TIRES AND TIRE

(71) Applicant: Toyo Tire Corporation, Itami-shi (JP)

(72) Inventor: Shuhei Yamamoto, Itami-shi (JP)

(73) Assignee: Toyo Tire Corporation, Itami-shi (JP)

(21) Appl. No.: 19/436,218

(22) Filed: Dec. 30, 2025

(30) Foreign Application Priority Data
Jan. 9, 2025 (JP) 2025-003507

(51) Int. Cl. C08L 7/00; B60C 1/00; C08K 3/04

(52) U.S. Cl. CPC C08L 7/00; B60C 1/0016; C08K 3/04; C08L 2205/025; C08L 2207/20

(57) ABSTRACT

The rubber composition for tires according to an embodiment includes an unvulcanized diene-based rubber and a reclaimed rubber. The reclaimed rubber contains natural rubber and butadiene rubber as a rubber polymer, the amount of the natural rubber in the rubber polymer is 70 mass % or more, the toluene-insoluble gel component content in the reclaimed rubber is 60 mass % or more and less than 80 mass %, and the ratio Mw/Mn of the weight average molecular weight Mw to the number average molecular weight Mn of the tetrahydrofuran-eluted fraction of the reclaimed rubber is 3.5 or less. The rubber composition for tires contains the reclaimed rubber in an amount of 1 to 15 mass %.

### BACKGROUND OF THE INVENTION

### 1. Field of the Invention

The present invention relates to a rubber composition for tires and also to a tire using the same.

### 2. Description of Related Art

From the standpoint of waste disposal and effective utilization of resources, rubber products such as waste tires have been recycled, and use of reclaimed rubbers obtained by reclaiming used rubber products has been considered. For example, JP2003-128843A proposes mixing a 10- to 300-mesh raw material reclaimed rubber with a diene-based rubber and applying shear at a maximum shear rate of 300/sec or more, thereby improving fracture characteristics, abrasion resistance, crack growth resistance, and heat generation characteristics.

JPH11-236464A proposes a rubber composition containing a reclaimed rubber and a unvulcanized raw material rubber, the reclaimed rubber being obtained by a reclaiming treatment including applying heat and shear force to a vulcanized rubber. In the rubber composition, the toluene-insoluble gel component content in the reclaimed rubber is 40 mass % or more, and the rubber network chain density in the gel component is 1/20 to ¼ of the network chain density of the vulcanized rubber.

Tire Reclaimed Rubber; Product Guide, [online], Asahi Reclaimed Rubber Co., Ltd., [searched on Dec. 19, 2024], Internet <URL. https.//asahi-rec.com/%E8%A3%BD%E5%93%81%E6%A1%88%E5%86%85/>, discloses that with respect to reclaimed tire rubbers manufactured by Asahi Reclaimed Rubber Co., Ltd., used truck and bus tires (particularly only the tread surface thereof) are used as the main raw material, and such a reclaimed rubber is used as a compounding ingredient in rubber products such as tires for trucks, buses, passenger cars, and the like.

### SUMMARY OF THE INVENTION

The oil pan method, which is known as a method for producing a reclaimed rubber, is a method in which a reclaiming agent is added to coarsely ground vulcanized rubber, and the mixture is heat-treated in an autoclave and then refined using finishing rolls or the like, thereby giving a reclaimed rubber. However, in the oil pan method, rubber molecular chains are prone to degradation under the influence of the heat treatment using a reclaiming agent.

Therefore, even when a reclaimed rubber obtained by the oil pan method is added to a new unvulcanized diene-based rubber and used, the fracture characteristics and low heat generation properties may significantly deteriorate. In order to make improvements in this respect, a reclaimed rubber produced by the oil pan method using only the tread rubber of tires for trucks and buses as the raw material, which has a high proportion of natural rubber and is highly strong, is sometimes used, but this has not necessarily produced a satisfactory result. That is, although this solves the problems with fracture characteristics in some cases, further improvements are required for low heat generation properties.

In light of the above points, an object of an embodiment of the invention is to improve the low heat generation properties of a rubber composition for tires containing a reclaimed rubber, while suppressing deterioration in the fracture characteristics.

The invention includes the following embodiments.

[1]A rubber composition for tires, including an unvulcanized diene-based rubber and a reclaimed rubber, in which
the reclaimed rubber contains natural rubber and butadiene rubber as a rubber polymer, the amount of the natural rubber in the rubber polymer is 70 mass % or more, the toluene-insoluble gel component content in the reclaimed rubber is 60 mass % or more and less than 80 mass %, and the ratio Mw/Mn of the weight average molecular weight Mw to the number average molecular weight Mn of the tetrahydrofuran-eluted fraction of the reclaimed rubber is 3.5 or less, and
the reclaimed rubber is contained in an amount of 1 to 15 mass %.

[2] The rubber composition for tires according to [1], in which the reclaimed rubber has a tensile strength of 6 to 12 MPa and an elongation at break of 200 to 350% as measured in accordance with JIS K6313:1999.

[3] The rubber composition for tires according to [1] or [2], in which 100 parts by mass of the unvulcanized diene-based rubber contains 50 parts by mass or more of unvulcanized natural rubber.

[4] The rubber composition for tires according to any one of [1] to [3], in which 100 mass % of the rubber polymer contained in the reclaimed rubber contains 75 to 90 mass % of natural rubber and 10 to 25 mass % of butadiene rubber.

[5] The rubber composition for tires according to any one of [1] to [4], in which the weight average molecular weight Mw of the tetrahydrofuran-eluted fraction of the reclaimed rubber is 40,000 to 90,000, and the number average molecular weight Mn of the tetrahydrofuran-eluted fraction of the reclaimed rubber is 15,000 to 35,000.

[6] The rubber composition for tires according to any one of [1] to [5], in which the reclaimed rubber has an acetone extract content of 10 to 20 mass % as measured in accordance with ASTM D297-18, the reclaimed rubber has an ash content of 3 to 15 mass % as measured in accordance with ASTM D297-18, the reclaimed rubber has a carbon black content of 20 to 35 mass % as measured in accordance with ASTM E1131, and the reclaimed rubber has a rubber polymer content of 45 to 60 mass % as measured in accordance with ASTM E1131.

[7] The rubber composition for tires according to any one of [1] to [6], in which the reclaimed rubber is a reclaimed rubber that has been desulfurized by applying mechanical shear to a vulcanized rubber without adding a desulfurizing agent.

[8] The rubber composition for tires according to any one of [1] to [7], further including 10 to 150 parts by mass of a reinforcing filler per 100 parts by mass of the unvulcanized diene-based rubber.

[9]A tire having a rubber portion formed from the rubber composition for tires according to any one of [1] to [8].

[10] The tire according to [9], in which the rubber portion is a base tread.

According to an embodiment of the invention, it is possible to improve the low heat generation properties of a rubber composition for tires containing a reclaimed rubber, while suppressing deterioration in the fracture characteristics.

### DESCRIPTION OF EMBODIMENTS

A rubber composition according to this embodiment includes an unvulcanized diene-based rubber and a reclaimed rubber, and uses, as the reclaimed rubber, one which has a high natural rubber proportion and in which the amount of toluene-insoluble gel component and the molecular weight distribution Mw/Mn of the tetrahydrofuran-eluted fraction satisfy specific ranges.

The unvulcanized diene-based rubber is a diene-based rubber that has not undergone a vulcanization step, unlike the vulcanized rubber used as a raw material for the reclaimed rubber. Here, a diene-based rubber refers to a rubber having a repeating unit corresponding to a diene monomer having a conjugated double bond, and its polymer backbone contains a carbon-carbon double bond.

The unvulcanized diene-based rubber is not particularly limited, and, for example, natural rubber (NR), synthetic isoprene rubber (IR), styrene butadiene rubber (SBR), butadiene rubber (BR), and the like can be mentioned. Any one of them, or a combination of two or more kinds, can be used. Incidentally, the diene-based rubber may be an unmodified rubber or may also be a modified rubber that has been modified at the terminal, backbone, or the like.

In one embodiment, it is preferable that the unvulcanized diene-based rubber contains unvulcanized natural rubber. For example, it is preferable that 100 parts by mass of the unvulcanized diene-based rubber contains 50 parts by mass or more of unvulcanized natural rubber. The content is more preferably 70 parts by mass or more, and still more preferably 80 parts by mass or more, and may also be 100 parts by mass.

A reclaimed rubber is obtained by reclaiming a vulcanized rubber. In this embodiment, a reclaimed rubber containing natural rubber and butadiene rubber as a rubber polymer is used. That is, a reclaimed rubber obtained by subjecting a vulcanized rubber containing natural rubber and butadiene rubber to a reclaiming treatment is used. The vulcanized rubber is a rubber that contains natural rubber and butadiene rubber as a rubber polymer and is obtained through vulcanization with a vulcanizing agent such as sulfur added thereto.

In the reclaimed rubber, the amount of natural rubber in the rubber polymer is 70 mass % or more. That is, 100 mass % of the rubber polymer contained in the reclaimed rubber contains 70 mass % or more and less than 100 mass % of natural rubber and more than 0 mass % and 30 mass % or less of butadiene rubber. Preferably, 100 mass % of the rubber polymer contains 75 to 90 mass % of natural rubber and 10 to 25 mass % of butadiene rubber, and more preferably contains 75 to 85 mass % of natural rubber and 15 to 25 mass % of butadiene rubber. Incidentally, the rubber polymer may or may not contain other diene-based rubbers as optional components in addition to the natural rubber and butadiene rubber.

The vulcanized rubber used as a raw material for the reclaimed rubber may contain various additives generally used in rubber compositions, including fillers such as carbon black and silica, oils, zinc oxide, stearic acid, antioxidants, waxes, vulcanization accelerators, sulfur, and the like, as well as reaction products thereof, for example. Therefore, the reclaimed rubber may also contain these additives and/or their reaction products.

In this embodiment, the toluene-insoluble gel component content in the reclaimed rubber (hereinafter also referred to as gel component content) is 60 mass % or more and less than 80 mass %, and the ratio Mw/Mn of the weight average molecular weight Mw to the number average molecular weight Mn of the tetrahydrofuran-eluted fraction of the reclaimed rubber is 3.5 or less. With respect to the gel component content, the value of 60 mass % or more and less than 80 mass % is roughly comparable to that in a reclaimed rubber prepared by the oil pan method, indicating that the desulfurization of the vulcanized rubber has proceeded sufficiently. Meanwhile, the Mw/Mn ratio is also referred to as molecular weight distribution, and shows the degree of molecular weight variation among the individual molecules that make up the rubber polymer. An Mw/Mn value of 3.5 or less is smaller compared to a reclaimed rubber prepared by the oil pan method, indicating that the molecular weight variation in the rubber polymer is smaller and excessive scission of the molecular chains is suppressed. From the fact that the desulfurization of the vulcanized rubber has proceeded sufficiently whereas the molecular weight variation is suppressed in this way, it is believed that in the reclaimed rubber according to this embodiment, the sulfur crosslinks have been selectively desulfurized, making it possible to improve the low heat generation properties, while suppressing deterioration in the fracture characteristics.

The toluene-insoluble gel component content in a reclaimed rubber is the proportion of the gel component that remains undissolved when the reclaimed rubber is immersed in toluene, and a lower proportion indicates more advanced desulfurization. The gel component content is preferably 65 to 78 mass %, more preferably 70 to 76 mass %, and still more preferably 73 to 75 mass %. The method for measuring the gel component content is as described in the Examples section.

The ratio Mw/Mn is the ratio of the weight average molecular weight Mw to the number average molecular weight Mn of the fraction eluted when the reclaimed rubber is immersed in tetrahydrofuran, as measured by gel permeation chromatography (GPC). Mw/Mn is preferably 3.2 or less, and more preferably 3.0 or less. Since smaller Mw/Mn is more preferable, the lower limit is not particularly set, and Mw/Mn may be 1.5 or more, or 2.0 or more, for example.

The weight average molecular weight Mw of the tetrahydrofuran-eluted fraction of the reclaimed rubber is not particularly limited, but is preferably 90,000 or less, and more preferably 40,000 to 80,000. The number average molecular weight Mn of the tetrahydrofuran-eluted fraction of the reclaimed rubber is not particularly limited, but is preferably 15,000 to 35,000, and more preferably 20,000 to 30,000. Incidentally, the methods for measuring Mw, Mn, and Mw/Mn are as described in the Examples section.

In this embodiment, it is preferable that the reclaimed rubber has a tensile strength of 6 to 12 MPa and an elongation at break of 200 to 350% as measured in accordance with JIS K6313:1999. When the reclaimed rubber has such fracture characteristics, it is possible to enhance the improving effect on fracture characteristics in the rubber composition for tires.

The tensile strength of the reclaimed rubber is more preferably 6.5 to 10 MPa, and still more preferably 7 to 9 MPa. The elongation at break of the reclaimed rubber is more preferably 220 to 330%, and still more preferably 250 to 300%. The methods for measuring the tensile strength and elongation at break of the reclaimed rubber are as described in the Examples section.

In one embodiment, the acetone extract content in the reclaimed rubber is not particularly limited, and, for example, the acetone extract content measured in accordance with ASTM D297-18 may be 10 to 20 mass %. The ash content in the reclaimed rubber is not particularly limited, and, for example, the ash content measured in accordance with ASTM D297-18 may be 3 to 15 mass %. The carbon black content in the reclaimed rubber is not particularly limited, and, for example, the carbon black content measured in accordance with ASTM E1131 may be 20 to 35 mass %. The rubber polymer content in the reclaimed rubber is not particularly limited, and, for example, the rubber polymer content measured in accordance with ASTM E1131 may be 45 to 60 mass %. Here, the acetone extract contains free sulfur, resins, oils and fats, antioxidants, and the like, for example. The ash content includes inorganic components such as silica and zinc oxide, for example.

In one embodiment, as a reclaimed rubber having the above characteristics, a rubber reclaimed using mechanical shear force, rather than the conventional oil pan method, is favorably used. That is, it is preferable to use a reclaimed rubber that has been desulfurized through the application of mechanical shear without adding a desulfurizing agent (reclaiming agent). The temperature during shearing is not particularly limited, but it is preferably performed at a low temperature, for example, at room temperature to about 100° C. or less.

As specific examples of such a reclaimed rubber, it is preferable to use “Ecorr RNR30B01” or “Ecorr RNR40B11” manufactured by Rubber Resources B.V. These are reclaimed rubbers desulfurized, using the tread rubber of tires for trucks and buses as the raw material, by applying shear using Papenmeier mixer for about 6 minutes until a certain viscosity is reached. Incidentally, “Ecorr RNR40B11” is obtained by adding, to the reclaimed rubber after a reclaiming treatment, unvulcanized natural rubber in an amount of 1 to 15 mass % based on the reclaimed rubber and mixing them for about 3 minutes in a Banbury mixer in order to improve the fracture characteristics and processability of the reclaimed rubber.

The rubber composition for tires according to this embodiment contains the reclaimed rubber in an amount of 1 to 15 mass %. That is, 100 mass % of the rubber composition for tires incorporates 1 to 15 mass % of the reclaimed rubber. The content of the reclaimed rubber is more preferably 2 to 12 mass %, and still more preferably 3 to 8 mass %. Incidentally, the content of the reclaimed rubber per 100 parts by mass of the unvulcanized diene-based rubber is not particularly limited, and may be, for example, 1 to 30 parts by mass, 1.5 to 25 parts by mass, or 2 to 20 parts by mass.

The rubber composition for tires according to this embodiment may contain, in addition to the reclaimed rubber, various additives that are generally incorporated into rubber compositions for tires. For example, the rubber composition for tires may contain, as optional components, a reinforcing filler, stearic acid, zinc oxide, a wax, an antioxidant, an oil, a vulcanizing agent such as sulfur, a vulcanization accelerator, and the like.

In the rubber composition for tires, the reinforcing filler content is not particularly limited, and may be, for example, 10 to 150 parts by mass, 20 to 100 parts by mass, or 30 to 80 parts by mass per 100 parts by mass of the unvulcanized diene-based rubber. The reinforcing filler is preferably carbon black and/or silica, and more preferably carbon black.

In the rubber composition for tires, the stearic acid content is not particularly limited, and may be, for example, 0 to 10 parts by mass, 0.5 to 5 parts by mass, or 1 to 4 parts by mass per 100 parts by mass of the unvulcanized diene-based rubber.

In the rubber composition for tires, the zinc oxide content is not particularly limited, and may be, for example, 0 to 10 parts by mass, 0.5 to 5 parts by mass, or 1 to 4 parts by mass per 100 parts by mass of the unvulcanized diene-based rubber.

In the rubber composition for tires, the wax content is not particularly limited, and may be, for example, 0 to 5 parts by mass, or 0.1 to 3 parts by mass, per 100 parts by mass of the unvulcanized diene-based rubber.

In the rubber composition for tires, the antioxidant content is not particularly limited, and may be, for example, 0 to 10 parts by mass, 0.5 to 5 parts by mass, or 1 to 4 parts by mass per 100 parts by mass of the unvulcanized diene-based rubber.

In the rubber composition for tires, the vulcanizing agent content is not particularly limited, and may be, for example, 0.1 to 10 parts by mass, 0.5 to 5 parts by mass, or 1 to 4 parts by mass per 100 parts by mass of the unvulcanized diene-based rubber.

In the rubber composition for tires, the vulcanization accelerator content is not particularly limited, and may be, for example, 0.1 to 10 parts by mass, 0.5 to 5 parts by mass, or 1 to 4 parts by mass per 100 parts by mass of the unvulcanized diene-based rubber.

The rubber composition for tires according to this embodiment can be made by kneading in the usual manner using a commonly used mixing machine such as a Banbury mixer, a kneader, or a roll. That is, for example, in the first mixing stage, a reclaimed rubber is added to an unvulcanized diene-based rubber and also other additives excluding a vulcanizing agent and a vulcanization accelerator are added thereto and mixed. Subsequently, in the final mixing stage, a vulcanizing agent and a vulcanization accelerator are added to the resulting mixture and mixed, thereby preparing a rubber composition for tires.

The rubber composition for tires according to this embodiment can be used for tires (preferably pneumatic tires) of various sizes for various applications, such as tires for passenger cars and large-sized tires for trucks and buses (heavy-duty tires). With respect to application sites in a tire, applications to various sections of a tire, such as treads, sidewalls, and bead parts, are possible. A preferred application site is a base tread, more preferably the base tread of a heavy-duty tire.

The tire according to this embodiment has a rubber portion formed from the rubber composition for tires described above. The tire is produced as follows. The rubber composition is formed into a predetermined shape in the usual manner, for example, by extrusion. The obtained formed product is combined with other tire members to make a green tire. The green tire is vulcanization-molded at 130 to 190° C., for example. As a result, a tire having, in its rubber portion, a vulcanized rubber of the rubber composition described above can be produced.

A tire according to a preferred embodiment is a tire having a base tread formed from the rubber composition described above. Specifically, some tire tread rubbers have a two-layer structure composed of an outer cap tread that comes into contact with the road surface and a base tread that is disposed inside the cap tread. In one embodiment, it is preferable that the base tread is formed from a vulcanized rubber obtained by vulcanization-molding the rubber composition described above.

### EXAMPLES

Hereinafter, examples of the invention will be shown, but the invention is not limited to these examples.

### [Reclaimed Rubber]

### (1) Products Used

### Reclaimed Rubber 1:

“Ecorr RNR40B11” manufactured by Rubber Resources B.V., obtained by adding unvulcanized natural rubber to a reclaimed rubber produced by mechanical shear force (unvulcanized natural rubber content: 10 mass %). Acetone extract content: 12 mass %, ash content: 6 mass %, carbon black content: 26 mass %, rubber polymer content: 57 mass %

### Reclaimed Rubber 2:

“Ecorr RNR30B01” manufactured by Rubber Resources B.V, reclaimed rubber produced by mechanical shear force. Acetone extract content: 12 mass %, ash content: 6 mass %, carbon black content: 27 mass %, rubber polymer content: 54 mass %

### Reclaimed Rubber 3 (Comparative Example):

“High-Strength Reclaimed Rubber” manufactured by Asahi Reclaimed Rubber Co., Ltd., reclaimed rubber prepared by oil pan method.

### (2) Composition Analysis of Reclaimed Rubber

The rubber polymer composition of the reclaimed rubbers 1 to 3 was measured by gas chromatography (GC) in accordance with JIS K6231-2:2007. The details are as follows.

The reclaimed rubber was cut into small pieces and subjected to acetone extraction as a pretreatment. Specifically, soluble components were extracted with acetone using an automatic Soxhlet extraction apparatus (“E-800” manufactured by Nihon BUCHI K.K.). The extraction conditions were in accordance with JIS K6229:2015, and the treatment was performed at 90° C. for 8 hours using the solvent acetone. About 10 mg of the reclaimed rubber from which additives had been removed by acetone extraction was weighed as a sample. Using a gas chromatography apparatus “GC2010Plus” manufactured by Shimadzu Corporation, the sample was loaded into the apparatus and pyrolyzed, the pyrolyzed components were passed through the column to separate each component, and the separated components were detected by the detector to determine the peak areas of isoprene, butadiene, and styrene, respectively. From the proportions of these peak areas, the proportions of natural rubber (NR), butadiene rubber (BR), and styrene butadiene rubber (SBR) were determined. The conditions for pyrolysis and gas chromatography are as follows.
Carrier gas: He
Carrier gas flow rate: 25.0 cm/s
Column type: “HP-1” manufactured by Agilent J&W
Column size: 0.25 mm×30 m×0.25 μm
Sample introduction method: Split, 1/50
Sample vaporization chamber temperature: 280° C.
Column bath temperature (program): 40° C. (5 min)→(raised at 10° C./min)→200° C.→(raised at 20° C./min)→280° C. (5 min)
Detector type: FID
Make-up gas type, flow rate: N₂, 45 mL/min
Hydrogen gas flow rate: 40 mL/min
Air flow rate: 450 mL/min

Incidentally, prior to the measurement, the presence or absence of Li was analyzed by ICP-OES (inductively coupled plasma optical emission spectroscopy), and the presence or absence of SBR was determined from the results.

Incidentally, with respect to the reclaimed rubber 1, because unvulcanized natural rubber cannot be separated from a reclaimed rubber and measured, the measurement was performed with the unvulcanized natural rubber being included (the same applies to the measurement of gel component content and fracture characteristics described below).

The results are as shown in Table 1 below. In the reclaimed rubbers 2 and 3, the rubber polymer was composed of NR and BR, and the NR proportion was 80 mass %. In the reclaimed rubber 1, the NR proportion was 91 mass %. However, because 10 mass % of unvulcanized natural rubber is contained, it can be understood that the rubber polymer contained in the reclaimed rubber excluding the unvulcanized natural rubber contains 90 mass % of NR and 10 mass % of BR.

TABLE 1

| | | | | Reclaimed |
|---|---|---|---|---|
| | | | | Rubber 3 |
| | | Reclaimed | Reclaimed | (High-Strength |
| | | Rubber 1 | Rubber 2 | Reclaimed |
| | | (RNR40B11) | (RNR30B01) | Rubber) |
| SBR Determination | | No SBR | No SBR | No SBR |
| (Li Presence/Absence) | | | | |
| Rubber Polymer | NR | 91 | 80 | 80 |
| Proportions | SBR | 0 | 0 | 0 |
| (mass %) | BR | 9 | 20 | 20 |

### (3) Measurement of Toluene-Insoluble Gel Component Content

The gel component content of the reclaimed rubbers 1 to 3 was measured by the following method. That is, for each of the reclaimed rubbers 1 to 3, a test piece (referred to as “piece A”) weighing 0.1 g was accurately measured and immersed in 100 times its mass of toluene for 48 hours to cause swelling. The swollen test piece was taken out, and excess toluene on the surface was wiped off, followed by drying for 12 hours to remove the toluene. The mass of this dried test piece (referred to as “piece B”) was measured, and the gel component content was calculated using the following formula.

$$Gel component content ( mass \% ) = ( mass of piece B / mass of piece A ) \times 100$$

The results are as shown in Table 2 below. The gel component content in the reclaimed rubber 2 was 74.5 mass %, which was almost the same as the gel component content in the reclaimed rubber 3 prepared by the oil pan method. Therefore, it was found that in the reclaimed rubber 2, the desulfurization of the vulcanized rubber had progressed to the degree comparable to the reclaimed rubber 3. With respect to the reclaimed rubber 1, because the gel component content in the test piece containing unvulcanized natural rubber was 73.5 mass %, and part of the unvulcanized natural rubber was insoluble in toluene as a bound rubber, it can be understood that the gel component content in the reclaimed rubber excluding the unvulcanized natural rubber is within a range of 60 mass % or more and less than 80 mass %.

### (4) Measurement of Mw, Mn and Mw/Mn of Tetrahydrofuran-Eluted Fraction

With respect to the reclaimed rubbers 2 and 3, the molecular weight of the fraction eluted with tetrahydrofuran was measured by gel permeation chromatography (GPC). The details are as follows.

The reclaimed rubber was immersed in tetrahydrofuran (grade 1) for 3 days, and the resulting eluted fraction was used as a sample. The sample was filtered through a polytetrafluoroethylene (PTFE) membrane filter and placed in a vial. The filtered sample (target sample) and a polystyrene standard sample for a calibration curve (calibration curve sample) were subjected to the measurement using a GPC apparatus (“HLC-8320GPC” manufactured by Tosoh Corporation). Each peak obtained from the calibration curve sample was acquired, followed by setting based on the molecular weight measured by the manufacturer attached to the polystyrene standard sample, and each peak obtained from the target sample was analyzed. The measurement conditions were set as follows: column temperature: 40° C., flow rate: 0.35 mL/min, column: TSKgel Super HZM-M manufactured by Tosoh Corporation×3, sample concentration: 10 mg/10 mL, injection volume: 20 μL, mobile phase: THF, detector: differential refractive index detector (RI), exclusion limit molecular weight: 4.00E+06. From the analysis results, the polystyrene-equivalent Mw, Mn, and Mw/Mn of the tetrahydrofuran-eluted fraction were determined.

The results are as shown in Table 2 below. In the reclaimed rubber 3, the Mw/Mn of the tetrahydrofuran-eluted fraction was 5.1, while in the reclaimed rubber 2, the Mw/Mn of the tetrahydrofuran-eluted fraction was 2.9, that is, the molecular weight distribution was narrower. As described above, in the reclaimed rubber 2, the gel component content was comparable to that in the reclaimed rubber 3 prepared by the oil pan method, and the desulfurization of the vulcanized rubber had proceeded sufficiently, while the Mw/Mn was small, and the molecular weight variation was suppressed. Therefore, it can be said that the sulfur crosslinks in the reclaimed rubber 2 have been selectively desulfurized. Incidentally, with respect to the reclaimed rubber 1, because the unvulcanized natural rubber cannot be separated, the Mw, Mn, and Mw/Mn of the reclaimed rubber itself cannot be measured. However, because its desulfurization was performed under lower-temperature conditions than that of the reclaimed rubber 2, there is less scission of the molecular chains, and therefore it can be said that the Mw/Mn is equal to or smaller than that of the reclaimed rubber 2.

TABLE 2

| | | | Reclaimed |
|---|---|---|---|
| | | | Rubber 3 |
| | Reclaimed | Reclaimed | (High-Strength |
| | Rubber 1 | Rubber 2 | Reclaimed |
| | (RNR40B11) | (RNR30B01) | Rubber) |
| Toluene-Insoluble Gel | 73.45 | 74.48 | 75.58 |
| Component Content | | | |
| (mass %) | | | |
| Number Average | — | 22947 | 29640 |
| Molecular Weight Mn | | | |
| Weight Average | — | 66494 | 152120 |
| Molecular Weight Mw | | | |
| Molecular Weight | — | 2.90 | 5.13 |
| Distribution Mw/Mn | | | |

### (5) Measurement of Fracture Characteristics of Reclaimed Rubber

The tensile strength and elongation at break of the reclaimed rubbers 1 to 3 were measured in accordance with JIS K6313:1999. Specifically, in accordance with 5.6 (Tensile Test) of the same standard, 5.0 parts by mass of zinc oxide, 1.0 part by mass of stearic acid, 3.0 parts by mass of sulfur, and 1.0 part by mass of a vulcanization accelerator CBS were added per 100 parts by mass of the rubber polymer in the reclaimed rubber and kneaded to make a rubber sheet. The rubber sheet was press-vulcanized at a temperature of 141° C. for 20 minutes, 30 minutes, or 40 minutes, and the tensile strength and the elongation at break were measured by the method specified in JIS K6251:2017. Among the measured values at different vulcanization times, one showing the highest tensile strength was employed.

The results are as shown in Table 3 below.

TABLE 3

| | | | Reclaimed |
|---|---|---|---|
| | | | Rubber 3 |
| | Reclaimed | Reclaimed | (High-Strength |
| | Rubber 1 | Rubber 2 | Reclaimed |
| | (RNR40B11) | (RNR30B01) | Rubber) |
| Tensile Strength (MPa) | 10.2 | 7.6 | 14.8 |
| Elongation at Break (%) | 313 | 270 | 389 |

### [Incorporated Components in Rubber Composition]

The following components were used as components incorporated into the rubber composition.
Natural rubber: RSS #3 manufactured by Southland Rubber
Carbon black ISAF: “SEAST 6” manufactured by Tokai Carbon Co., Ltd.
Carbon black T-NS: “SEAST N” manufactured by Tokai Carbon Co., Ltd.
Stearic acid: “Stearic Acid N-50” manufactured by NOF Corporation
Zinc oxide: “Zinc Oxide, Type 2” manufactured by Mitsui Mining & Smelting Co., Ltd.
Wax: “OZOACE-2701” manufactured by Nippon Seiro Co., Ltd.
Antioxidant 6C: “Nocrac 6C” manufactured by Ouchi Shinko Chemical Industrial Co., Ltd.
Antioxidant RD: “Vulkanox HS/LG” manufactured by LANXESS
Vulcanization accelerator CZ: “Nocceler CZ-G” manufactured by Ouchi Shinko Chemical Industrial Co., Ltd.
Sulfur: “Oil-Treated 150-Mesh Powdered Sulfur” manufactured by Tsurumi Chemical Industry Co., Ltd.

### [Rubber Composition Evaluation Method]

### (1) Fracture Characteristics

The tensile strength of a vulcanized rubber was measured in accordance with JIS K6251:2017. The test piece was in a No. 3 dumbbell shape with a thickness of 2 mm. The measurement was performed under the conditions of a test temperature of 23±2° C. and a relative humidity of 50±5%. The test piece was set in a tensile tester and subjected to a tensile test at a speed of 500 mm/min. Tensile force was applied until the test piece fractured, and the maximum load (N) until fracture was determined. The maximum load was divided by the cross-sectional area of the test piece before the test (mm²) to determine the tensile strength (MPa). The result was expressed as an index taking the value of Comparative Example 1 in Table 4, the value of Comparative Example 2 in Table 5, the value of Comparative Example 3 in Table 6, the value of Comparative Example 4 in Table 7, or the value of Comparative Example 5 in Table 8, as 100. A larger index indicates better fracture characteristics.

### (2) Low Heat Generation Properties

In accordance with JIS K6255:2013, the rebound (rebound resilience) of a vulcanized rubber was measured using a Lupke-type rebound resilience tester under the conditions of a test temperature of 23° C.±2° C. and a relative humidity of 50±5%. The thickness of the test piece was set to 12.5 mm, and the ratio of the height after rebound to the drop height was determined as the rebound resilience. The result was expressed as an index taking the value of Comparative Example 1 in Table 4, the value of Comparative Example 2 in Table 5, the value of Comparative Example 3 in Table 6, the value of Comparative Example 4 in Table 7, or the value of Comparative Example 5 in Table 8, as 100. The larger the index, the higher the rebound resilience, indicating better low heat generation properties.

### First Experiment Example

Using a Banbury mixer, a rubber composition was prepared according to the formulation (parts by mass) shown in Table 4 below. Specifically, first, the compounding agents excluding sulfur and a vulcanization accelerator were added to unvulcanized natural rubber and kneaded, and then sulfur and a vulcanization accelerator were added to the resulting kneaded product and kneaded, thereby preparing rubber compositions of Examples 1 and 2 and Comparative Example 1. In the first experiment example, the amount of reclaimed rubber added was set to 1.3 mass %.

In Table 4, with respect to the amount of reclaimed rubber 1 incorporated, the numerical values in parentheses represent the parts by mass of net reclaimed rubber, excluding unvulcanized natural rubber contained in the reclaimed rubber 1. In the case of using the reclaimed rubber 1, the amount of unvulcanized natural rubber contained in the rubber composition, including the amount of unvulcanized natural rubber contained in the reclaimed rubber 1, was set to 100 parts by mass. The same applies to Tables 5 to 8 below.

The rubber compositions thus obtained were each vulcanized at 160° C. for 20 minutes to make a test piece of a predetermined shape, and the fracture characteristics and the low heat generation properties were evaluated. The results are as shown in Table 4 below. In Examples 1 and 2, in which the reclaimed rubbers 1 and 2 were incorporated instead of the reclaimed rubber 3 prepared by the oil pan method, compared to Comparative Example 1, the low heat generation properties were improved without impairing the fracture characteristics.

TABLE 4

| | Comp. Ex. 1 | Ex. 1 | Ex. 2 |
|---|---|---|---|
| Formulation (parts by mass) | | | |
| Natural Rubber | 100 | 99.8 | 100 |
| Carbon Black ISAF | 30 | 30 | 30 |
| Carbon Black T-NS | 10 | 10 | 10 |
| Reclaimed Rubber 1 | | 2.2 (2.0) | |
| Reclaimed Rubber 2 | | | 2.0 |
| Reclaimed Rubber 3 | 2.0 | | |
| Stearic Acid | 2.0 | 2.0 | 2.0 |
| Zinc Oxide | 3.0 | 3.0 | 3.0 |
| Wax | 0.5 | 0.5 | 0.5 |
| Antioxidant 6C | 0.8 | 0.8 | 0.8 |
| Antioxidant RD | 0.5 | 0.5 | 0.5 |
| Vulcanization Accelerator CZ | 1.25 | 1.25 | 1.25 |
| Sulfur | 1.6 | 1.6 | 1.6 |
| Amount of Reclaimed Rubber | 1.3 | 1.3 | 1.3 |
| Added (mass %) | | | |
| Evaluation (index) | | | |
| Fracture Characteristics | 100 | 101 | 100 |
| Low Heat Generation Properties | 100 | 101 | 101 |

### Second Experiment Example

Rubber compositions of Examples 3 and 4 and Comparative Example 2 were prepared in the same manner as in the first experiment example, except for following the formulation (parts by mass) shown in Table 5 below. Using the obtained rubber compositions, the fracture characteristics and the low heat generation properties were evaluated in the same manner as in the first experiment example. In the second experiment example, the amount of reclaimed rubber added was set to 3.2 mass %. The results are as shown in Table 5.

TABLE 5

| | Comp. Ex. 2 | Ex. 3 | Ex. 4 |
|---|---|---|---|
| Formulation (parts by mass) | | | |
| Natural Rubber | 100 | 99.44 | 100 |
| Carbon Black ISAF | 30 | 30 | 30 |
| Carbon Black T-NS | 10 | 10 | 10 |
| Reclaimed Rubber 1 | | 5.56 (5.0) | |
| Reclaimed Rubber 2 | | | 5.0 |
| Reclaimed Rubber 3 | 5.0 | | |
| Stearic Acid | 2.0 | 2.0 | 2.0 |
| Zinc Oxide | 3.0 | 3.0 | 3.0 |
| Wax | 0.5 | 0.5 | 0.5 |
| Antioxidant 6C | 0.8 | 0.8 | 0.8 |
| Antioxidant RD | 0.5 | 0.5 | 0.5 |
| Vulcanization Accelerator CZ | 1.25 | 1.25 | 1.25 |
| Sulfur | 1.6 | 1.6 | 1.6 |
| Amount of Reclaimed Rubber | 3.2 | 3.2 | 3.2 |
| Added (mass %) | | | |
| Evaluation (index) | | | |
| Fracture Characteristics | 100 | 102 | 101 |
| Low Heat Generation Properties | 100 | 104 | 103 |

### Third Experiment Example

Rubber compositions of Examples 5 and 6 and Comparative Example 3 were prepared in the same manner as in the first experiment example, except for following the formulation (parts by mass) shown in Table 6 below. Using the obtained rubber compositions, the fracture characteristics and the low heat generation properties were evaluated in the same manner as in the first experiment example. In the third experiment example, the amount of reclaimed rubber added was set to 5.1 mass %. The results are as shown in Table 6.

TABLE 6

| | Comp. Ex. 3 | Ex. 5 | Ex. 6 |
|---|---|---|---|
| Formulation (parts by mass) | | | |
| Natural Rubber | 100 | 99.11 | 100 |
| Carbon Black ISAF | 30 | 30 | 30 |
| Carbon Black T-NS | 10 | 10 | 10 |
| Reclaimed Rubber 1 | | 8.89 (8.0) | |
| Reclaimed Rubber 2 | | | 8.0 |
| Reclaimed Rubber 3 | 8.0 | | |
| Stearic Acid | 2.0 | 2.0 | 2.0 |
| Zinc Oxide | 3.0 | 3.0 | 3.0 |
| Wax | 0.5 | 0.5 | 0.5 |
| Antioxidant 6C | 0.8 | 0.8 | 0.8 |
| Antioxidant RD | 0.5 | 0.5 | 0.5 |
| Vulcanization Accelerator CZ | 1.25 | 1.25 | 1.25 |
| Sulfur | 1.6 | 1.6 | 1.6 |
| Amount of Reclaimed Rubber | 5.1 | 5.1 | 5.1 |
| Added (mass %) | | | |
| Evaluation (index) | | | |
| Fracture Characteristics | 100 | 100 | 101 |
| Low Heat Generation Properties | 100 | 109 | 107 |

### Fourth Experiment Example

Rubber compositions of Examples 7 and 8 and Comparative Example 4 were prepared in the same manner as in the first experiment example, except for following the formulation (parts by mass) shown in Table 7 below. Using the obtained rubber compositions, the fracture characteristics and the low heat generation properties were evaluated in the same manner as in the first experiment example. In the fourth experiment example, the amount of reclaimed rubber added was set to 10.2 mass %. The results are as shown in Table 7.

TABLE 7

| | Comp. Ex. 4 | Ex. 7 | Ex. 8 |
|---|---|---|---|
| Formulation (parts by mass) | | | |
| Natural Rubber | 100 | 98.12 | 100 |
| Carbon Black ISAF | 30 | 30 | 30 |
| Carbon Black T-NS | 10 | 10 | 10 |
| Reclaimed Rubber 1 | | 18.88 (17) | |
| Reclaimed Rubber 2 | | | 17 |
| Reclaimed Rubber 3 | 17 | | |
| Stearic Acid | 2.0 | 2.0 | 2.0 |
| Zinc Oxide | 3.0 | 3.0 | 3.0 |
| Wax | 0.5 | 0.5 | 0.5 |
| Antioxidant 6C | 0.8 | 0.8 | 0.8 |
| Antioxidant RD | 0.5 | 0.5 | 0.5 |
| Vulcanization Accelerator CZ | 1.25 | 1.25 | 1.25 |
| Sulfur | 1.6 | 1.6 | 1.6 |
| Amount of Reclaimed Rubber | 10.2 | 10.2 | 10.2 |
| Added (mass %) | | | |
| Evaluation (index) | | | |
| Fracture Characteristics | 100 | 97 | 99 |
| Low Heat Generation Properties | 100 | 115 | 112 |

### Fifth Experiment Example

Rubber compositions of Comparative Examples 5 to 7 were prepared in the same manner as in the first experiment example, except for following the formulation (parts by mass) shown in Table 8 below. Using the obtained rubber compositions, the fracture characteristics and the low heat generation properties were evaluated in the same manner as in the first experiment example. In the fifth experiment example, the amount of reclaimed rubber added was set to 18.5 mass %. The results are as shown in Table 8.

TABLE 8

| | Comp. | Comp. | Comp. |
|---|---|---|---|
| | Ex. 5 | Ex. 6 | Ex. 7 |
| Formulation (parts by mass) | | | |
| Natural Rubber | 100 | 96.22 | 100 |
| Carbon Black ISAF | 30 | 30 | 30 |
| Carbon Black T-NS | 10 | 10 | 10 |
| Reclaimed Rubber 1 | | 37.78 (34) | |
| Reclaimed Rubber 2 | | | 34 |
| Reclaimed Rubber 3 | 34 | | |
| Stearic Acid | 2 | 2 | 2 |
| Zinc Oxide | 3 | 3 | 3 |
| Wax | 0.5 | 0.5 | 0.5 |
| Antioxidant 6C | 0.8 | 0.8 | 0.8 |
| Antioxidant RD | 0.5 | 0.5 | 0.5 |
| Vulcanization Accelerator CZ | 1.25 | 1.25 | 1.25 |
| Sulfur | 1.6 | 1.6 | 1.6 |
| Amount of Reclaimed Rubber | 18.5 | 18.5 | 18.5 |
| Added (mass %) | | | |
| Evaluation (index) | | | |
| Fracture Characteristics | 100 | 96 | 94 |
| Low Heat Generation Properties | 100 | 118 | 121 |

As shown in Tables 4 to 8, in the case where a composition incorporating the reclaimed rubber 3 prepared by the oil pan method was used as control, in Examples 1 to 8 incorporating the reclaimed rubbers 1 and 2 produced using mechanical shear force, the fracture characteristics were substantially equivalent to those of the control, while the low heat generation properties were improved. With respect to the amounts of reclaimed rubbers 1 and 2 added, from the above results, it is believed that the above effects are produced at 1 to 15 mass %, and particularly high effects are produced at 2 to 12 mass %. Meanwhile, in the fifth experiment example in which the amounts of reclaimed rubbers 1 and 2 added were 18.5 mass %, although the low heat generation properties were superior compared to Comparative Example 5 (control), the fracture characteristics were inferior.

Incidentally, with respect to the various numerical ranges described herein, the upper and lower limits thereof can be arbitrarily combined, and all such combinations are incorporated herein as preferred numerical ranges. In addition, the description of a numerical range “X to Y” means X or more and Y or less.

What is claimed is:

1. A rubber composition for tires, comprising an unvulcanized diene-based rubber and a reclaimed rubber, wherein
the reclaimed rubber contains natural rubber and butadiene rubber as a rubber polymer, the amount of the natural rubber in the rubber polymer is 70 mass % or more, the toluene-insoluble gel component content in the reclaimed rubber is 60 mass % or more and less than 80 mass %, and the ratio Mw/Mn of the weight average molecular weight Mw to the number average molecular weight Mn of the tetrahydrofuran-eluted fraction of the reclaimed rubber is 3.5 or less, and
the reclaimed rubber is contained in an amount of 1 to 15 mass %.

2. The rubber composition for tires according to claim 1, wherein the reclaimed rubber has a tensile strength of 6 to 12 MPa and an elongation at break of 200 to 350% as measured in accordance with JIS K6313:1999.

3. The rubber composition for tires according to claim 1, wherein 100 parts by mass of the unvulcanized diene-based rubber contains 50 parts by mass or more of unvulcanized natural rubber.

4. The rubber composition for tires according to claim 1, wherein 100 mass % of the rubber polymer contained in the reclaimed rubber contains 75 to 90 mass % of natural rubber and 10 to 25 mass % of butadiene rubber.

5. The rubber composition for tires according to claim 1, wherein the weight average molecular weight Mw of the tetrahydrofuran-eluted fraction of the reclaimed rubber is 40,000 to 90,000, and the number average molecular weight Mn of the tetrahydrofuran-eluted fraction of the reclaimed rubber is 15,000 to 35,000.

6. The rubber composition for tires according to claim 1, wherein the reclaimed rubber has an acetone extract content of 10 to 20 mass % as measured in accordance with ASTM D297-18, the reclaimed rubber has an ash content of 3 to 15 mass % as measured in accordance with ASTM D297-18, the reclaimed rubber has a carbon black content of 20 to 35 mass % as measured in accordance with ASTM E1131, and the reclaimed rubber has a rubber polymer content of 45 to 60 mass % as measured in accordance with ASTM E1131.

7. The rubber composition for tires according to claim 1, wherein the reclaimed rubber is a reclaimed rubber that has been desulfurized by applying mechanical shear to a vulcanized rubber without adding a desulfurizing agent.

8. The rubber composition for tires according to claim 1, further comprising 10 to 150 parts by mass of a reinforcing filler per 100 parts by mass of the unvulcanized diene-based rubber.

9. A tire comprising a rubber portion formed from the rubber composition for tires according to claim 1.

10. The tire according to claim 9, wherein the rubber portion is a base tread.
